(19) United States
(12) Patent Application Publication
(10) Pub. No.: US 2004/0132526 A1
(43) Pub. Date: Jul. 8, 2004

(54) Computer interactive and game playing system

(76) Inventors: Yu-Chen Liu, Keelung (TW); Tzu-Chen Liu, Keelung (TW)

Correspondence Address: Yu-Chen Liu & Tzu-Chen Liu, P.O. Box No. 6-57, Junghe, Taipei, 235, TW

(21) Appl. No.: 10/737,966

(22) Filed: Dec. 18, 2003

(30) Foreign Application Priority Data
Dec. 23, 2002 (TW) 091137082

(51) Int. Cl. A63F 13/00

(52) U.S. Cl. 463/17

(57) ABSTRACT

A computer interactive teaching and game playing system mainly connects a set of electronic percussion instrument or striking game tool with a computer main unit. An execution program is preloaded in the computer main unit. When the computer main unit uses a multimedia playing device to read audio-visual data preloaded on an audio-visual medium, the execution program commands a peripheral audio-visual device to generate relative sounds and images to allow a user to strike the electronic percussion instrument or game tool with correct beats and positions. The striking signals are transmitted back to the computer main unit so as to achieve the interactive teaching and game play purposes. In addition, the user competes with another user in online games via the computer main unit.

### BACKGROUND OF THE INVENTION

(a) Field of the Invention

The present invention relates to a computer interactive and game playing system, and particularly, to a computer interactive and game playing system, in that a set of electronic percussion music instrument or a striking game tool is connected to a computer main unit or connected to the internet via the computer main unit. In conjunction with commands of a peripheral audio-visual device of the computer main unit, a user is allowed to strike and play the electronic percussion music instrument or the striking game tool with correct beats.

(b) Description of the Prior Art

Among all kinds of music instruments, percussion instruments are the easiest ones to learn. With some common music knowledge, a user can enjoy the fun of striking a percussion music instrument. However, for a novice, especially for one who is a beginner at learning to play jazz or Latin drums, a most frequently encountered difficulty is that one has to practice in a sound-insolated place in order to prevent making noise and bothering the others.

For an electronic percussion music instrument, electronic drums for instance, noise issues might be eliminated by controlling a volume thereof. However, lowering down the volume makes the user unable to feel the beat intensities of the percussion music instrument. In addition, a most important thing is that, during practice, it is also less likely for an instructor to feel whether intensities of the learner's striking beats are appropriate. Therefore, the instructor may become less adequate in providing the learner with best guidance and suggestions.

Furthermore, during practice, a learner playing a percussion music instrument usually listens to a part of music and practices according to the beats in the music. For example, a learner of jazz drums may play a piece of rock-and-roll music first, and then practices according to the drumming beats in the rock-and-roll music as if a drummer in the band. However, hearing both practicing and original drumming, the learner or the instructor is unable to identify wrong beats to tell which beats need to be reinforced. Of course, if electronic drums are used, headphones can be used to overcome the problem of mixed sounds. Nevertheless, without an instructor correcting errors next to a learner, the learner usually has to spend a long time in practicing and groping in order to improve playing techniques.

In view of the obstacles occurred when a learner practices playing a percussion music instrument, the inventor of the present invention proposes a set of electronic percussion music instrument connected with an extensively used computer main unit. In conjunction with commands from a computer peripheral audio-visual device, a user is able to practice playing the music instrument with correct beats. Therefore, according to the live music play recorded in the computer main unit, the learner fully realizes whether beats, rhythms and intensities are correct thereby achieving interactive teaching purposes using a computer.

Moreover, supposed the electronic percussion music instrument is replaced with a striking game tool, the invention is also able to offer entertaining game functions.

Also, the computer main unit becomes accessible to transmissions of powerful data when connected to the internet. Therefore, using connection to the internet, two or more users are allowed to compete with each other in online games via the internet.

### SUMMARY OF THE INVENTION

The primary object of the invention is to provide a computer interactive system of an electronic percussion music instrument and a game playing tool, in that a set of electronic percussion music instrument or a striking game tool is connected to a computer main unit, with the computer main unit preloaded with an execution program. When the computer main unit reads audio-visual data saved in an audio-visual storage medium via a multimedia playing device, it orders a peripheral audio-visual device thereof to generate relative sounds and images under commands of the execution program. Thus, a user is allowed to play the set of electronic percussion music instrument or the striking game tool with correct beats. The percussion signals are transmitted back to the computer main unit, thereby completing interactive teaching and game playing purposes.

Another object of the invention is to provide a computer interactive system of an electronic music instrument and a striking game tool, in that a computer main unit may be connected to the internet, so that two or more users can compete in online games via the internet.

The other object of the invention is to provide a computer interactive system of an electronic music instrument and a striking game tool, in that an execution program loaded in a computer main unit includes an authentication mechanism for capturing and checking a serial number of an original audio-visual storage medium. If audio-visual data recorded in the audio-visual storage medium lack a legally recorded serial number, the execution program fails to generate relative sounds or images for the peripheral audio-visual device, so as to safeguard the legal copyright and assist eliminating pirated editions and rectifying social morale.

### BRIEF DESCRIPTION OF THE DRAWINGS

FIG. 1 shows an overall system structural diagram according to the invention.

FIG. 2 shows an elevational diagram illustrating an embodiment according to the invention being applied in online games via an internet server.

FIG. 3 shows a flowchart illustrating an execution program in an embodiment according to the invention.

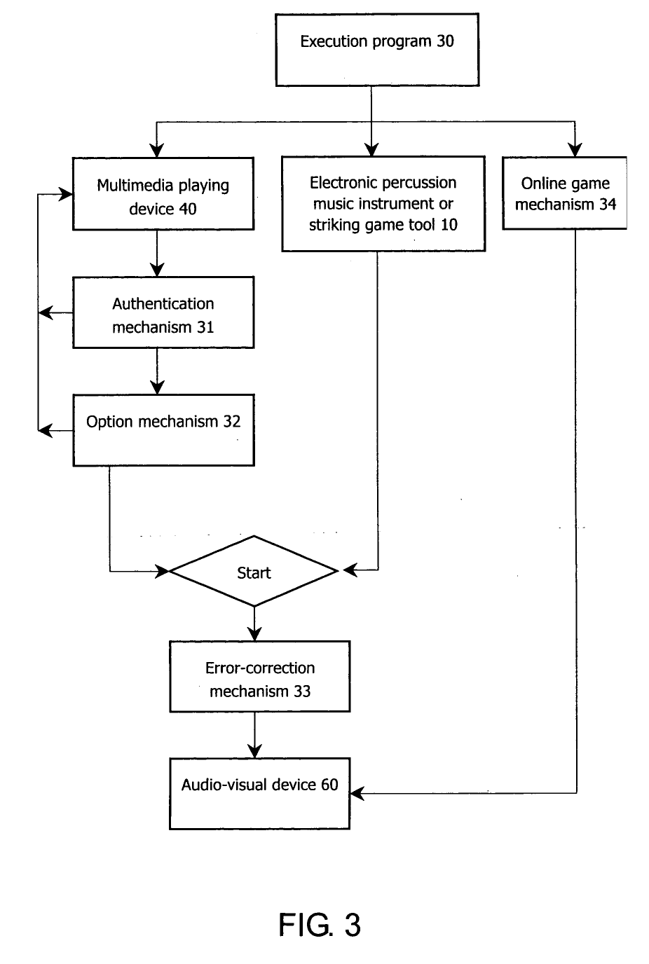

FIG. 4 shows a flowchart illustrating an authentication mechanism in an execution program in an embodiment according to the invention.

FIG. 5 shows a flowchart illustrating a option mechanism of an execution program in an embodiment according to the invention.

FIG. 6 shows a flowchart illustrating an error-correction mechanism of an execution program in an embodiment according to the invention.

FIG. 7 shows a flowchart illustrating the invention being applied for online games.

### DETAILED DESCRIPTION OF THE PREFERRED EMBODIMENTS

To better understand the invention, detailed descriptions shall be given with the accompanying drawings below.

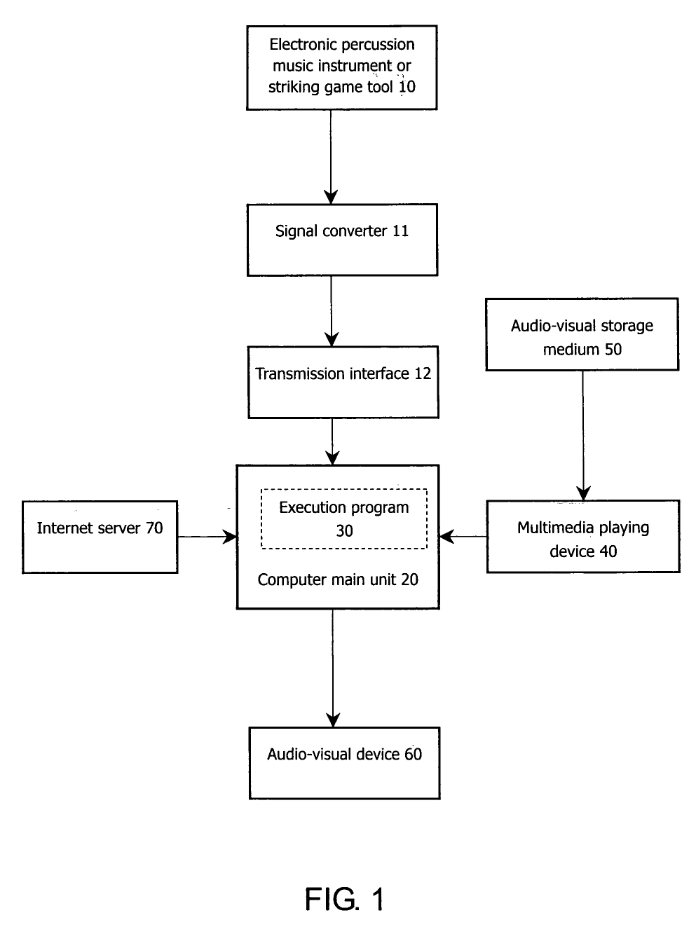

As indicated in FIG. 1, the invention of a computer interactive teaching and game playing system connects a set of electronic percussion music instrument or a striking game tool (10) with a computer main unit (20) preloaded with an execution program (30). When the computer main unit (20) reads audio-visual data saved in an audio-visual storage medium (50) via a multimedia playing device (40), it orders a peripheral audio-visual device (60) thereof to generate relative sounds and images under the commands of the execution program (30), thereby allowing a user to play the set of electronic percussion music instrument or the striking game tool (10) with correct beats. The percussion signals are also transmitted back to the computer main unit (20), such that the execution program (30) commands the computer (20) to compare and record the beats and rhythms as well as to check if beat intensities are correct, thereby accomplishing interactive teaching and game playing purposes.

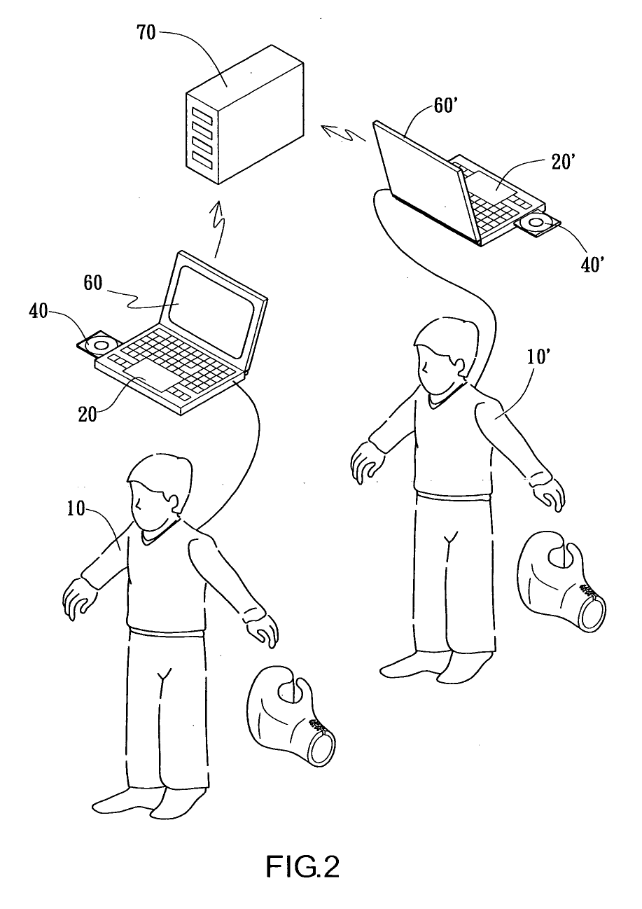

With reference of FIG. 2, the computer main unit (20) is connected to the internet, and forms a network with another user via an internet server (70) for online games. It is essential that the other user be similarly connected to the internet via a computer main unit (20′), and has a set of electronic percussion music instrument or a striking game tool (10′). Thus, through the internet server (70), two or more users can compete with each other in online games. Various elements of the invention shall be described in detail below.

Again referring to FIG. 1, the abovementioned electronic percussion music instrument (10) is connected with the computer main unit (20) via a signal converter (11) and a transmission interface (12). A plurality of buzzing tabs (reeds) is disposed inside the electronic percussion music instrument set (10). When being stricken, the buzzing tabs generate vibration analog signals, which operate with a mechanism of a prior art and will not be further described. When a user strikes the electronic percussion music instrument (10), the electronic percussion music instrument (10) generates and transmits different vibration analog signals to the signal converter (11) that converts the analog signals to digital signals further transmitted to the computer main unit (20) through the transmission interface (12).

The aforesaid electronic percussion music instrument (10) may also be replaced by a striking game tool (10). Various locations of the striking game tool (10) are installed with a plurality of tabs (reeds). For example, for combat games, the striking game tool can be devised in a shape of a human or animal, and has various locations thereof installed with a plurality of tabs (reeds). Similarly, when striking the striking game tool, the tabs (reeds) generate different vibration analog signals to the signal converter (11). The analog signals are converted to digital signals further transmitted to the computer main unit (20) via the transmission interface (12).

Specifications of the transmission interface (12) are preferably standard computer specifications such as USB, IEEE1394, IDE/ATAPI or SCSI.

The abovementioned computer main unit (20) is connected with the electronic percussion music instrument (10) via the transmission interface (12) and also is also connected with a multimedia playing device (40) and a peripheral audio-visual device (60). The computer main unit (20) is connected to the internet as well. Two or more users are allowed to compete with each other via a network formed by the internet server (70), so as to accomplishing online game effects.

Wherein, the computer main unit (20) at least includes a desktop personal computer (PC), a portable notebook PC, a personal digital assistant (PDA), and a pocket PC.

The multimedia playing device (40) is mainly for reading the audio-visual data in various formats such a MPEG1, MPEG2, WMA, MP3 and AAC. The audio-visual data are saved in the audio-visual storage medium (50) at least including application devices such as a camcorder, a compact disc (CD) machine (for example, CD-RW, and DVD-ROM etc.), a card reader (for example, PC Card Reader, CF Card Reader, SM Card Reader and MMC Card Reader), a DVD player, a VCD player, a CD player and a CD Discman.

The audio-visual storage medium (50) at least includes a magnetic recording medium (for example, a music cassette and a video cassette), an optical recording medium (for example, CD-DA, CD-I, Photo-CD, Video-CD and DVD) capable of storing audio-visual data in various formats and the recently developed silicon chip recording medium (for example, CF Card, PC Card, SMC Card, MMC Card and MS Card).

The computer peripheral audio-visual device (60) at least includes a monitor and a speaker in any format.

Referring to FIG. 2, the computer main unit (20, 20′) is a notebook PC. The notebook PC already has a built-in compact disc machine serving as the aforesaid multimedia playing device (40, 40′), and a liquid-crystal display (LCD) serving as the aforesaid peripheral audio-visual device (60, 60′).

The main function of the execution program (30) preloaded in the computer main unit (20) is for commanding the peripheral audio-visual device (60) to generate relative sounds and images after the computer main unit (20) reads the audio-visual data preloaded in the audio-visual storage medium (50) via the multimedia playing device (40). In addition, when the user strikes the electronic percussion music instrument or the striking game tool (10), the signals transmitted back to the computer (20) enable the computer main unit (20) to compare and record beats, rhythms and beat intensities via the execution program (30) thereby making the peripheral audio-visual device (60) generate relative sounds and images. Through comparisons of the sounds and images respectively generated by the two different signal sources namely the multimedia playing device (40) and the electronic percussion music instrument or the striking game tool (10), the user is able to distinguish whether the beats, rhythms and beat intensities generated by the electronic percussion music instrument or the striking game tool (10) match with those generated by the multimedia playing device (40). Hence, the user is able to determine if the played music is correct so as to achieve computer interactive teaching and game playing purposes.

Referring to FIG. 2, the execution program (30) in the computer interactive teaching and game playing system according to the invention further includes an authentication mechanism (31), an option mechanism (32) an error-correction mechanism (33), and an online game mechanism (34).

Wherein, the authentication mechanism (31), the option mechanism (32) and the error-correction mechanism (33) are for use of a single user, whereas the online game mechanism (34) can be used between multiple users for online games when a user is connected to the internet.

When being used by a single user in a singe machine, the electronic percussion music instrument or striking game tool (10) and the multimedia playing device (40) are respectively connected with the computer main unit (20). The execution program (30) commands the signals generated by the multimedia playing device (40) to sequentially pass the authentication mechanism (31) and the option mechanism (32) in order to enter a start status. Whereas, signals generated by the electronic percussion music instrument or striking game tool (10) directly enter the starting status. After being analyzed by the error-correction mechanism (33), both kinds of signals make the audio-visual device (60) generate sounds and images so as to achieve the abovementioned effects.

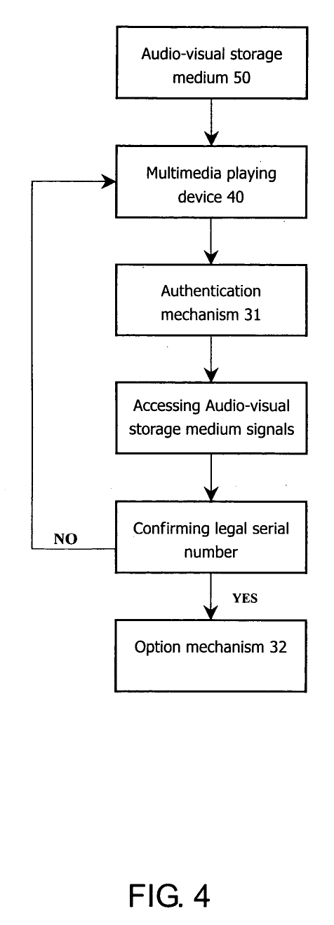

As indicated in FIG. 4, the authentication mechanism (31) retrieves, checks and confirms a serial number of the original audio-visual storage medium (50). If the audio-visual storage medium (50) is an original edition, it allows signals generated by the multimedia playing device (40) to enter the option mechanism (32) as a next stage. If the audio-visual data recorded in the audio-visual storage medium (50) lack a legally recorded serial number, the next stage cannot be executed and no relative sounds or images are generated for the peripheral audio-visual device (60), so as to safeguard the legal copyright as well as assist eliminating the pirate editions and rectifying social morale.

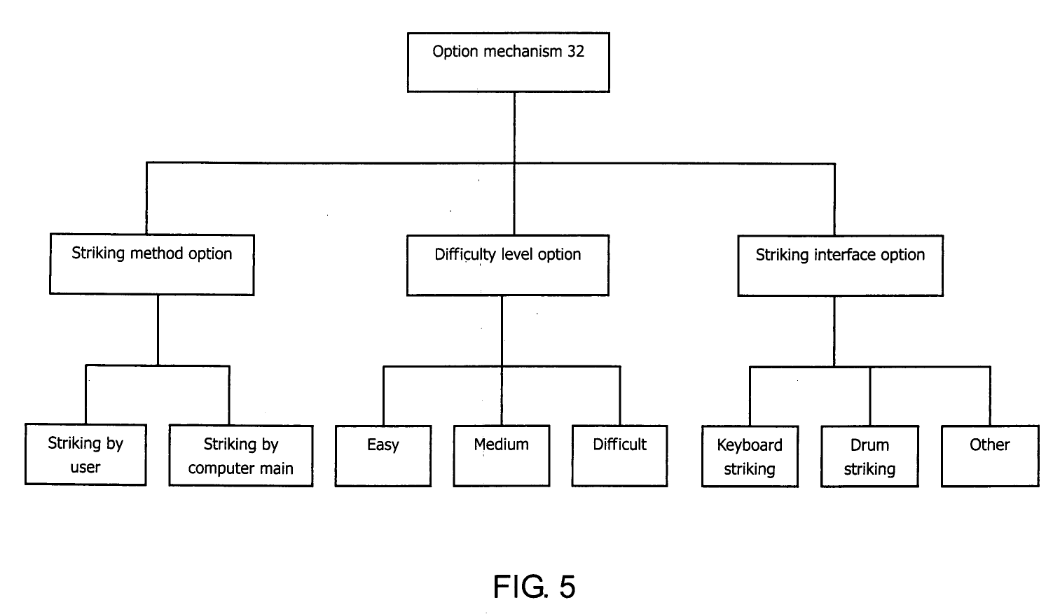

Referring to FIG. 5, the option mechanism (32) further includes a striking method option, a difficulty level option and a striking interface option. Wherein, the striking method option mainly provides the user with options as whether to strike on one's own or through the computer main unit (20). To strike through the computer main unit (20), the execution program (30) commands the computer main unit (20) to simulate the audio-visual data recorded in the audio-visual storage medium (50) in order to make exemplary striking for the user. The difficulty level option includes three choices—easy, medium and difficult levels. It mainly provides a standard for the error-correction mechanism (33) at the next stage to compare with. The striking interface option includes a keyboard striking, a drum set striking, and a game striking. It mainly provides the user with options of learning, practice or playing games.

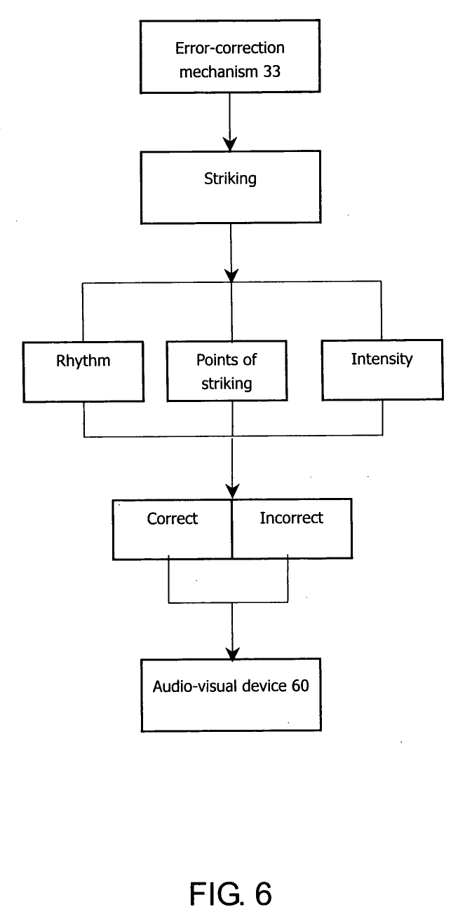

After choosing the setting for each item via the option mechanism (32), the user enters a start status. At this point, the signals generated by the multimedia playing device (40) and the electronic percussion music instrument set (10) respectively enter the error-correction mechanism (33). If the option mechanism chooses the computer (20) for striking, then the computer main unit (20) imitates the striking. As indicated in FIG. 5, when the electronic percussion music instrument (10) is stricken, mainly based on the standard chosen for comparison, the error-correction mechanism (33) commands the computer main unit (20) to calculate and compare signals of the stricken beats, rhythms and beat intensities with the audio-visual data recorded in the audio-visual storage medium (50) to check if they match as shown in FIG. 6. The error-correction mechanism (33) also records and counts the two kinds of signals to command the audio-visual device (60) to generate sounds and images. Therefore, through recording the sounds and images, the user is able to distinguish and improve the weakness of the striking so as to achieve interactive teaching and game playing purposes.

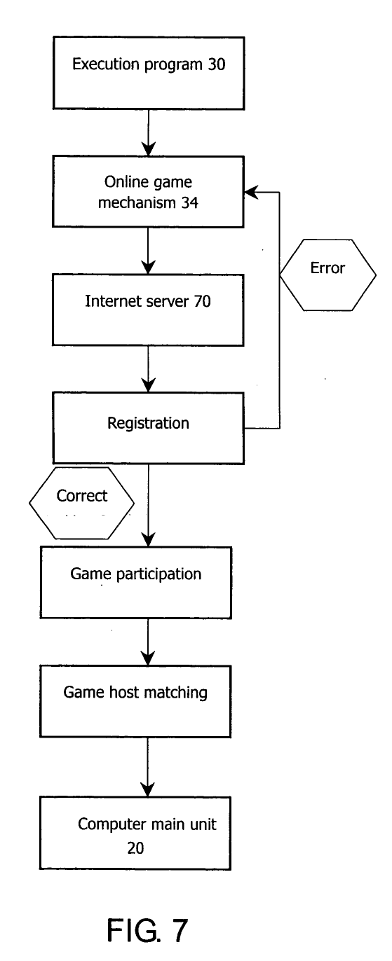

Referring to FIGS. 2 and 7, the aforesaid online game mechanism (34) of the execution mechanism (30) can serve multiple users for online games when a user is connected with the internet. When the user enters the execution program (30) and selects the online game mechanism (34), the execution program (30) commands the computer main unit (20) to link up to the internet. Via the internet server (70), registration, authentication, game participations and host matching processes are carried out as in common online games, and hence shall not be unnecessarily illustrated. At least two users are allowed to compete with each other via the internet server (70). However, as described before, it is essential that the other users have same conditions as connecting to the internet via a computer main unit (20′) and having an electronic percussion music instrument or striking game tool (20′) to accomplish online game effects.

In other words, the internet server (70), apart from having wired transmissions as general internet servers and loading the aforesaid execution program (30), also provides functions of member mechanism, matching mechanism and final scoring mechanism (when competing with others, the internet server usually acts as a referee that gives final scores).

Furthermore, when the invention is in application, the execution program may also renew software via the internet server (70) as other prior techniques. This particular function is similar to that of common online games and shall not be further described.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A computer interactive teaching and game playing system connecting a set of electronic percussion music instrument or a striking game tool with a computer main unit preloaded with an execution program; wherein, when the computer main unit reads audio-visual data saved in an audio-visual storage medium via a multimedia playing device and after the execution program verifies whether the audio-visual data in the audio-visual storage medium is an original edition, the execution program commands a computer peripheral audio-visual device to generate relative sounds and images for allowing a user to play the electronic percussion music instrument or the striking game tool with correct beats; and percussion signals are transmitted back to the computer main unit such that the execution program commands the computer main unit to compare and record the beats or check if rhythms are correct, thereby achieving interactive teaching and game playing purposes.

2. The computer interactive teaching and game playing system in accordance with claim 1, wherein the electronic percussion music instrument is connected with the computer main unit via a signal converter and a transmission interface; and when striking the electronic percussion music instrument, striking signals are sent to the signal converter and converted into digital signals further transmitted to the computer main unit via the transmission interface.

3. The computer interactive teaching and game playing system in accordance with claim 1, wherein various locations of the striking game tool are installed with a plurality of tabs; and vibrations analog signals generated by the tabs are transmitted to the signal converter, which converts the digital converter further transmitted to the computer main unit via the transmission interface.

4. The computer interactive teaching and game playing system in accordance with claim 1, wherein the execution program further includes an authentication mechanism, an option mechanism and an error-correction mechanism; the execution program commands the signals generated by the multimedia playing device to sequentially pass the authentication mechanism and the option mechanism to enter a start status, whereas the signals generated by the electronic percussion music instrument directly enter the start status; and after being analyzed by the error-correction mechanism, both kinds of signals make the audio-visual device generate corresponding sounds and images.

5. The computer interactive teaching and game playing system in accordance with claim 1, wherein the execution program further has an online game option for connecting to the internet and allowing a user to play online games with more than one other user; when the user enters an online game option, the execution program links the computer main unit to the internet, and performs account registration, authentication, game participation and host matching, thereby enabling at least two users to play online games with each other via the internet server.

6. The computer interactive teaching and game playing system in accordance with claim 1, wherein the execution mechanism has the authentication mechanism for retrieving, checking and confirming a serial number of the original audio-visual storage medium in order to command signal generated by the multimedia playing device to enter a next stage.

7. The computer interactive teaching and game playing system in accordance with claim 1, wherein the execution program has the option mechanism further having a striking method option, a difficulty level option and a striking interface option.

8. The computer interactive teaching and game playing system in accordance with claim 1, wherein the execution mechanism has the error-correction mechanism; when the electronic percussion music instrument is stricken, the error-correction mechanism commands the computer to calculate and compare the signals of the stricken beats, rhythms and beat intensities with the audio-visual data recorded in the audio-visual storage medium to check if they match; and it also records and counts the two kinds of signals to command the audio-visual device to generate sounds and images.

9. The computer interactive teaching and game playing system in accordance with claim 1, wherein the computer at least includes a desktop personal computer (PC), a portable notebook PC, a personal digital assistant (PDA) and a pocket PC.

10. The computer interactive teaching and game playing system in accordance with claim 1, wherein the multimedia playing device at least includes application devices such as a camcorder, a compact disc (CD) machine (for example, CD-RW and DVD-ROM), a card reader (for example, PC Card Reader, CF Card Reader, SM Card Reader and MMC Card Reader), a DVD player, a VCD player, a CD player and a CD Discman.

11. The computer interactive teaching and game playing system in accordance with claim 1, wherein the audio-visual storage medium at least includes a magnetic recording medium, an optical recording medium and a silicon chip recording medium

12. The computer interactive teaching and game playing system in accordance with claim 1, wherein the audio-visual device at least includes a monitor and a speaker.
